(19) United States
(12) Patent Application Publication
(10) Pub. No.: US 2010/0064565 A1
(43) Pub. Date: Mar. 18, 2010

(54) Gripping Promotional Applique

(76) Inventor: Robert S. Lear, Chatsworth, CA (US)

Correspondence Address: CHANCELLOR IP, 3463 RED BLUFF CT., SEMI VALLEY, CA, 93063, US

(21) Appl. No.: 12/579,213

(22) Filed: Oct. 14, 2009

Related U.S. Application Data
(63) Continuation-in-part of application No. 12/143,012, filed on Jun. 20, 2008.
(60) Provisional application No. 60/936,723, filed on Jun. 22, 2007.

(51) Int. Cl. G09F 3/18

(52) U.S. Cl. 40/661.11

(57) ABSTRACT

An appliqué includes multiple layers and provides a gripping function.

### PRIORITY CLAIM

This is a continuation in part patent application. It claims the benefit of U.S. patent application Ser. No. 12/143,012 filed Jun. 20, 2008 which claims the benefit of U.S. Prov. Pat. App. No. 60/936,723 filed Jun. 22, 2007.

### BACKGROUND OF THE INVENTION

1. Field of the Invention

The present invention relates to an appliqué for resisting relative motion between objects it separates and for displaying promotional material.

2. Discussion of the Related Art

A problem in using the human body to support objects such as computers, musical instruments and other objects is stability at the point(s) of contact between the object and the user. Because the contact point(s) on some such objects are finished by the manufacturer with slick or polished surfaces, undesirable instability including unintended movement or slippage of the object often results.

### SUMMARY OF THE INVENTION

The present invention utilizes an appliqué to enhance stability of objects supported by the human body and provides a means for displaying promotional messages.

The appliqué or any combination of layers comprising the appliqué can be in any shape or size and die, laser, roller or water cut to any desired design. Among other things, the appliqué of the present invention grips an object and a user to enhance the user's control of the object. The invention also enables the display of promotional messages by, among other things, utilizing opaque or transparent layers with associated messages that are affixed by any suitable means including silk screening, digital reproduction and other suitable means known in the art.

In yet other embodiments of the invention, the message or a design element can be located on or in various layers of the appliqué. For example, message media such as ink can be located on the outermost layer that touches the user, such as with the use of tacified or Plastisol type inks providing promotional utility while maintaining desirable non-slip characteristics.

Another object and advantage of this invention is not only through use of transparent or opaque material, screen print, digital reproduction, but also by embossing, cut through or any combination of. Promotional viability is thus obtained for customers, or those that require a design element added to the invention.

### BRIEF DESCRIPTION OF THE DRAWINGS

The present invention is described with reference to the accompanying figures. These figures, incorporated herein and forming part of the specification, illustrate the present invention and, together with the description, further serve to explain the principles of the invention and to enable a person skilled in the relevant art to make and use the invention.

FIG. 1A is an exploded view of an appliqué of the present invention.

FIG. 1B is a side-view of a multipart first layer of the invention of FIG. 1.

FIG. 2 is an exploded view of a layer of the invention of FIG. 1.

FIG. 3 shows the invention of FIG. 1 as it is used in one application.

### DETAILED DESCRIPTION OF THE PREFERRED EMBODIMENTS

The disclosure provided in the following pages describes examples of some embodiments of the invention. The designs, figures, and description are non-limiting examples of certain embodiments of the invention. For example, other embodiments of the disclosed device may or may not include the features described herein. Moreover, disclosed advantages and benefits may apply to only certain embodiments of the invention and should be not used to limit the disclosed inventions.

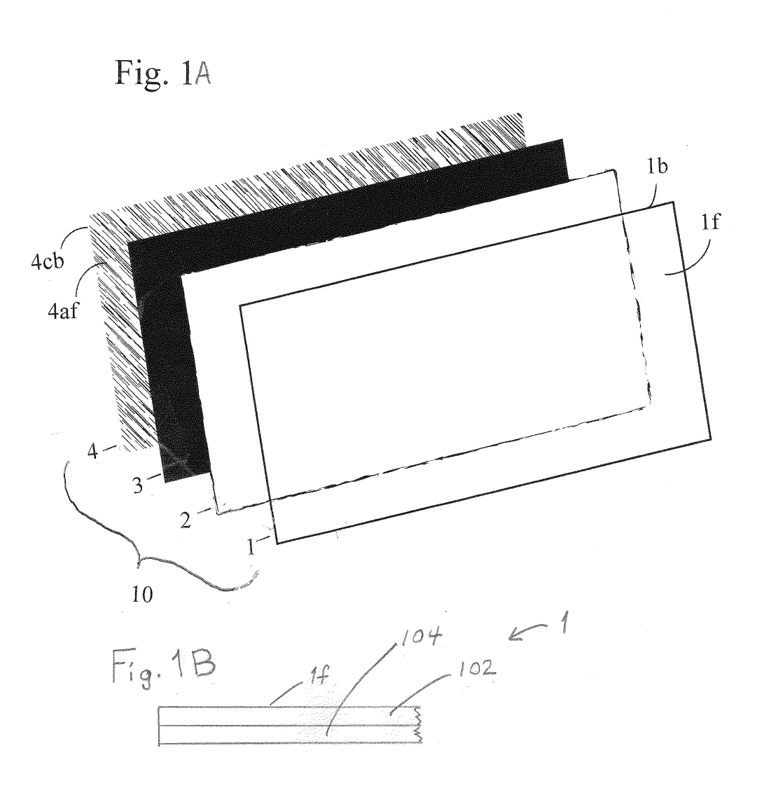

FIG. 1A shows an exploded view of an appliqué device in accordance with the present invention. Included in the appliqué are a plurality of layers including at least a first grip layer 1 and a second grip layer 4. In some embodiments, a message layer 2 and/or a cushioning layer 3 are included and located between the grip layers.

In an embodiment, the first grip layer 1 is a flexible polymer or natural material presenting a tacky or sticky free surface 1f. This layer is transparent or translucent. Materials of construction include one or more of clear rubber, poly vinyl chlorides (PVC), tacified PVC, styrenic block copolymer's (SBC), silicone materials including silicone rubbers and other suitably flexible materials. In various embodiments, the properties of such materials include a surface characteristic for enhancing frictional engagement such as a tacky surface.

FIG. 1B shows a side view of an embodiment where the first layer is a multipart layer. In some embodiments, the first layer includes an upper layer 102 and a lower layer 104. Here the lower layer may be made from any suitable material including one or more of the materials described above. In an embodiment, the upper layer is a suitable coating. Suitable coatings include any suitable friction enhancing coatings, tacky or sticky coatings such as silicone coatings and other coatings known by persons of ordinary skill in the art to enhance frictional engagement.

In some embodiments, the upper layer of the first layer 102 is made from a first clear or translucent polymeric material and the lower layer of the first layer 104 is made from a second polymeric material. For example, in this embodiment the properties of the upper layer can be optimized to enhance frictional engagement while the properties of the lower layer can be optimized to receive inks or other markings enabling fixation of message and/or graphic content to the composite first layer. As used herein, polymeric materials include copolymeric materials.

In various embodiments, a message layer includes one or more of the expressive materials used in the printing, messaging, and other communications arts including the fine arts known by persons of ordinary skill in the art to be suitable for this application. Selected message media include ink or another contrasting material that is visibly distinguishable from its background and/or surroundings. Such other materials include one or more of flowable pigmented materials, solids forming symbols, shapes and designs, and materials able to be etched. Methods of application include those known to persons of ordinary skill in the art, for example, silk screening.

In an embodiment, the upper layer of the first layer 102 is made from styrenic block copolymer (e.g., a Krayton® G based compound available from Krayton Polymers U.S., LLC) and the lower layer of the first layer 104 is made from a suitable PVC material. In some embodiments, the upper layer is coextruded with the lower layer, for example, in a co-extrusion process from a sheet die where the molten layers fuse upon cooling. This type of embodiment includes a) materials in the upper layer 102 that are suited for presenting a surface having enhanced frictional engagement (SBC) and b) materials in the lower layer 104 that are suited for providing a surface having an affinity for marking materials such as printing inks. For example, PVC materials with surface tensions on the order of 42 dyne/cm and greater will typically be selected to provide a suitable substrate for printing inks and other marking materials benefitting from a similar surface tension.

In various embodiments, the first grip layer 1 has thicknesses in inches in the ranges of 0.01 to 0.25 and more preferred thicknesses in the range of 0.05 to 0.10. In some embodiments, the engaging quality of the free surface if is the result of and/or enhanced by a static electric charge carried by the appliqué.

An optional message layer 2 may be included with or without a message in layer 1. Message layer 2 lies in the plane indicated by the rectangular boundary line. While the message layer is bounded by the boundary line, this message layer need not be coextensive with the entire area within the boundary line. For example, to the extent the message is a word, then the message layer need only include the material required to form the message, here the letters making up the word; it is obvious that in some embodiments the “negative” of the word shape could also be formed. In other embodiments, the message layer may be coextensive with the entire area within the boundary line.

An optional cushioning layer 3 reduces user discomfort and the potential for object damage associated with forces exchanged between a user and the object 6. Where used, the cushioning layer is typically located between the first and second grip layers and is made of a foam material known in the art such as a foam made from ethylene, ethylene vinyl acetate, polyolefin elastomer, metallocene polyolefin elastomer, nitrile, polyethlyne, polyurethane, foamed rubbers, viscoelastic foams and other suitable materials.

The second grip layer 4 includes a surface 4af interfacing with another layer 1, 2, 3 and a surface 4cb for gripping an object such as a musical instrument 6. A fusion bond or an adhesive layer, such as a wet tape, transfer tape, or applied flowable adhesive, adheres the second grip layer to another layer 1, 2, 3 and forms, in some embodiments, the second grip layer. Typical adhesives for use between layers and objects include one or more of 3M Stock Nos. F9465PC, 9471 and 300 LSE. In some embodiments, a magnetic device affixed in part to the object and in part with the second grip layer effects the attachment.

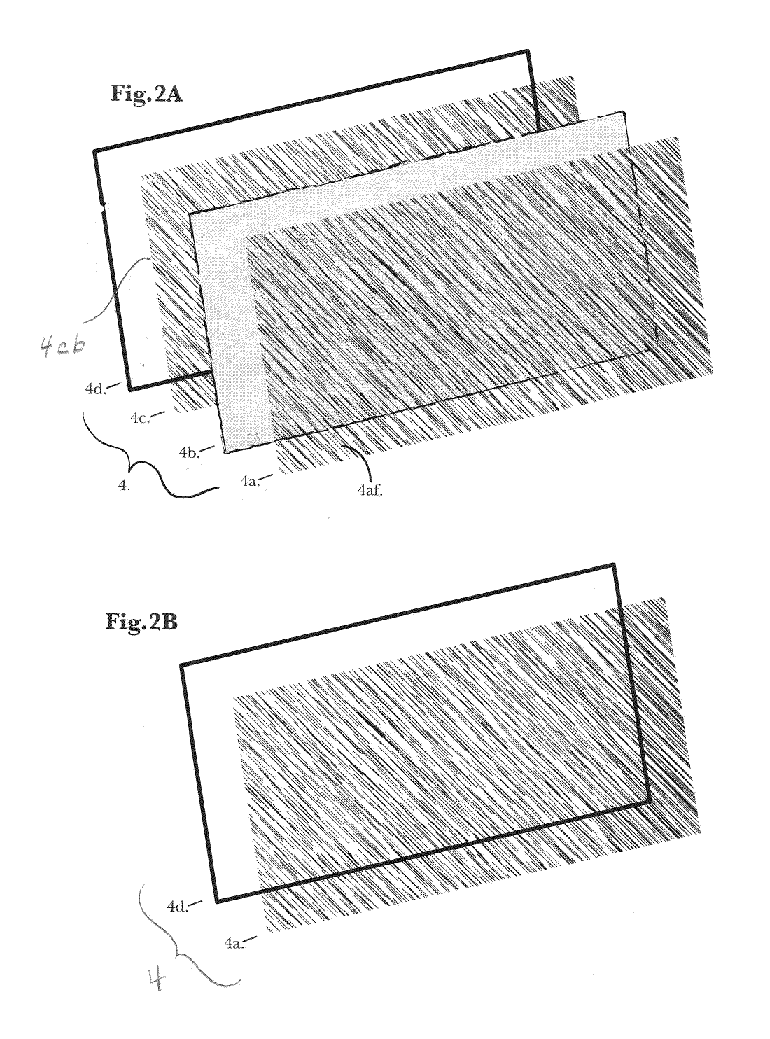

In an embodiment shown in FIG. 2, the second grip layer 4 may be formed of multiple layers. For example, in an embodiment, an adhesive layer 4a attaches a thin substrate 4b, such as a mylar film, to another layer 2, 3. Here, another adhesive layer 4c is for attaching the mylar film to an object 6. As shown in FIG. 2, an optional protective covering 4d protects the free surface of the mylar film 4cb. In some embodiments, the second grip layer includes a transfer adhesive such as a transfer adhesive made by 3M Corporation.

In various embodiments, the second grip layer 4 utilizes an appropriate type and application of adhesive to maintain the fixation between the object 6 and the appliqué 10 while the user and the appliqué are being separated. Moreover, when the user is separated from the appliqué, exposing the free surface of the appliqué 1f, the message layer(s) and its message(s) 1, 2 become visible through the transparent or translucent layer(s) separating the message layer(s) from the free surface.

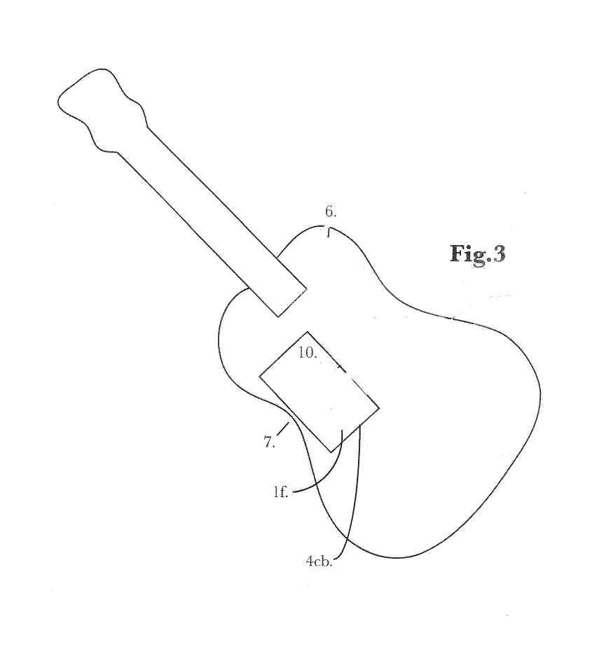

FIG. 3 is an isometric view in relation to an example object, a musical instrument in the form of a guitar. The appliqué is applied on the back of the instrument in a location that is consistent with a known point of contact between this particular instrument and the instrument user. Demonstrated here is an example of appliqué placement, on the back, lower section of the instrument for contact and enhanced stability between the user and the instrument. Here, the contact point is above a user's right knee and the appliqué comes into contact here to prevent slippage of the instrument and enhance control and playing precision available to the user.

As shown in FIG. 3, in operation the second grip layer 4 of the appliqué 10 is adhered to an object 6 in a location 7 where the object normally comes into contact with the user. While the user is normally supporting the object, the friction enhanced free surface if of the first grip layer 1 of the appliqué grips typically to either the body or the clothing of the user it contacts and tends to improve object stability by reducing relative motion between the user and the object. Where the user and the appliqué touch, the appliqué offers an enhanced coefficient of friction reducing instability of the object 6. Moreover, separation of the object and the user does not cause separation of the object and the appliqué; and, once the object and user are separated, observers may view the message of the message layer(s) 1, 2 at the free surface of the exposed grip layer.

In yet other embodiments, the first grip layer 1 can be used alone if manufactured with a material that provides a static cling adhesion between the invention and the instrument. This layer offers in addition to enhanced control of the instrument, an advertising canvas that can be directly silk screened or utilize reproduced artwork to provide a medium for promotional content as dictated by the customer.

What is claimed is:

1. An appliqué comprising:
a first surface removably immobilized by a non-adhesive first grip to a first object;
a second surface immobilized by a second grip to a second object;
the first grip being a frictional grip and the second grip being an adhesive grip;
the strength of the second grip being sufficient to resist separation of the second surface from the second object when the first surface is separated from the first object; and,
a promotional message layer being made visible to onlookers when the first surface is separated from the first object.

2. The appliqué of claim 1, further comprising a first grip layer through which the promotional message layer is visible.

3. The appliqué of claim 2 wherein material of the first grip layer in close proximity to the first object carries a static electric charge and enables a selectively breakable first grip on the first object.

4. The appliqué of claim 3 wherein the first object is a musician and the second object is a musical instrument.

5. The appliqué of claim 4 wherein the first object is a computer user and the second object is a computer.

6. The appliqué of claim 5 wherein the first object is a medical patient and the second object is a structure immobilizing a body part of the medical patient.

7. An appliqué comprising:
a first gripping layer for gripping a musician with a first frictional grip;
a second gripping layer for gripping a musical instrument with a second adhesive grip;
the first gripping layer including an upper layer fused to a lower layer;
the upper layer including a styrenic block copolymer material and the lower layer including a polyvinyl chloride material;
the surface tension of a surface of the lower layer exceeding 42 dyne/cm for enabling printing on said surface;
expressive media being printed on the lower layer and viewable through the upper layer;
the strength of the second grip being sufficient to resist separation of the second gripping layer from the musical instrument when the first gripping layer is separated from the musician; and,
the viewable expressive media being made visible to onlookers when the musician is separated from the first gripping layer.

8. The device of claim 7 wherein the upper and lower layers of the first gripping layer are co-extruded.

9. An appliqué method comprising the steps of:
providing first and second gripping layers, a griping strength of a first grip of the first layer being greater than a gripping strength of a second grip of the second layer;
including in an upper layer of the first gripping layer a styrenic block copolymer material;
including in a lower layer of the first gripping layer a polyvinyl chloride material;
providing a lower layer surface having a surface tension greater than 42 dyne/cm;
printing viewable expressive media on the lower layer surface;
the first grip gripping a first object and the second grip gripping a second object; and,
viewing the expressive media when the first grip ceases to grip the first object.

10. The method of claim 9 wherein the first object is a musician and the second object is a musical instrument.

11. The method of claim 9 wherein the first object is a medical patient and the second object is a structure immobilizing a body part of the medical patient.
